(19) United States
(12) Patent Application Publication
(10) Pub. No.: US 2022/0222749 A1
(43) Pub. Date: Jul. 14, 2022

(54) SYSTEMS AND METHODS FOR MONETIZING HOME EQUITY

(71) Applicant: Wells Fargo Bank, N.A., San Francisco, CA (US)

(72) Inventors: John Chuprevich, Davidson, NC (US); Jonathan A. Hartsell, Mooresville, NC (US); Patrick S. Schwaner, Indian Trail, NC (US); Christina Zikeli, Charoltte, NC (US)

(21) Appl. No.: 15/392,804

(22) Filed: Dec. 28, 2016

(51) Int. Cl. G06Q 40/06; G06Q 40/02; G06Q 30/04; G06Q 20/10

(52) U.S. Cl. CPC G06Q 40/06; G06Q 20/102; G06Q 30/04; G06Q 40/025

(57) ABSTRACT

An apparatus includes a biometric scanner and a processing circuit. The biometric scanner is configured to collect biometric data associated with a user. The processing circuit is communicably coupled to the biometric scanner. The processing circuit is configured to receive information regarding an equity value of a property of the user and receive one or more preferences of the user. The processing circuit is further configured to select one or more investment opportunities based on the equity value and the user preferences. The processing circuit is configured to provide the selected investment opportunities to the user, receive an indication of approval of one or more investment opportunities, and confirm the identity of the user with the biometric data to facilitate participation in the accepted investment opportunities.

### TECHNICAL FIELD

Embodiments of the present disclosure relate to monetizing home equity and rewarding homeownership.

### BACKGROUND

The equity value of a home can be used to take out a home equity line of credit (HELOC) or a second mortgage. In many instances, a HELOC or a second mortgage is sufficient for one or more goals of the homeowner (e.g., investing, home projects, etc.). That being said, simply acquiring or receiving a cash injection in the form of a HELOC or second mortgage simply patches or puts a band-aide over potential financial issues of the homeowner (assuming one or more financial issues or problems exist). Accordingly, better options for utilizing one's home equity are desired.

### SUMMARY

A first example embodiment relates to an apparatus. The apparatus includes a biometric scanner and a processing circuit. The biometric scanner is configured to collect biometric data associated with a user. The processing circuit is communicably coupled to the biometric scanner. The processing circuit is configured to receive information regarding an equity value of a property of the user and receive one or more preferences of the user. The processing circuit is further configured to select one or more investment opportunities based on the equity value and the user preferences. The processing circuit is configured to provide the selected investment opportunities to the user, receive an indication of an approval of one or more investment opportunities, and confirm the identity of the user with the biometric data to facilitate participation in the approved one or more investment opportunities.

Another example embodiment relates to a method. The method includes receiving, by a mobile investment circuit, financial information comprising an equity value of a property of the user and receiving one or more preferences of the user. The method further includes selecting, by the mobile investment circuit, one or more investment opportunities based on the equity value and the user preferences. The method further includes providing, by the mobile investment circuit, the selected investment opportunities to the user. The method includes receiving, by the mobile investment circuit, an indication of approval of one or more investment opportunities, confirming, by the mobile investment circuit, the identity of the user with biometric data associated with a user gathered by a biometric scanner, and facilitating, by the mobile investment circuit, participation in the accepted investment opportunities in response to confirming the identity of the user.

Another example embodiment relates to a system. The system includes a biometric scanner and a processing circuit. The processing circuit is communicably coupled to the biometric scanner. The processing circuit is configure to receive information regarding an equity value of a property of the user and receive one or more preferences of the user. The processing circuit is further configured to select one or more investment opportunities based on the equity value and the user preferences. The investment opportunities are selected by the processing circuit by selecting a loan as the investment in response to a determination that the equity value is above a predefined threshold and selecting a bond as the investment in response to a determination that the equity value is below the predefined threshold. The processing circuit is further configured to provide the selected investment opportunities to the user via a user interface, receive an indication of approval of one or more investment opportunities, and confirm the identity of the user with the biometric data to facilitate participation in the one or more approved investment opportunities.

These and other features, together with the organization and manner of operation thereof, will become apparent from the following detailed description when taken in conjunction with the accompanying drawings.

### BRIEF DESCRIPTION OF THE FIGURES

FIG. 1 is a diagram of a computing system, according to an example embodiment.

FIG. 2 is a diagram of the mobile device of FIG. 1, according to an example embodiment.

FIG. 3 is a diagram of the mobile investment circuit of FIG. 1, according to an example embodiment.

FIG. 4 is a flow diagram of monetizing home equity using the mobile investment circuit of FIG. 1, according to an example embodiment.

FIG. 5 is a flow diagram of a method of confirming the identity of the homeowner of FIG. 1, according to an example embodiment.

FIG. 6 is a diagram of an investment agreement generated by the mobile device of FIGS. 1 and 2, according to an example embodiment.

### DETAILED DESCRIPTION

Referring to the Figures generally, systems, methods, and apparatuses for monetizing home equity and providing rewards to a homeowner are provided according to various embodiments herein. According to one embodiment, a financial institution having a financial institution computing system can be configured to monetize home equity for a homeowner via a secure mechanism. The financial institution computing system may identify investment opportunities including, for example, loans, stock purchases, and/or bond purchases, which may be appealing to the homeowner and present the identified investment opportunities to the homeowner. The homeowner may review the investment opportunities on a mobile investment client application provided on a mobile device. The homeowner may then accept certain investment opportunities (i.e., “selected investments”) with an electronic signature via the mobile investment client application. The electronic signature may be a verification key or may utilize a biometric scanner. Beneficially, participation in the selected investments may result in the generation of an income stream for the homeowner. The financial institution can then utilize the income stream to provide rewards to the homeowner. The rewards may include, but are not limited to, paying or facilitating payment of utilities for the homeowner, paying groceries, day-to-day expenses of the homeowner, and/or paying off loans or debt. These and other features and benefits of the present disclosure are described more fully herein below.

The systems, methods, and apparatuses described herein may provide secure means for facilitating the monetization of home equity. Various forms of user identification and verification can be employed to prevent the threat of hacking. In some embodiments, the identification and verification may be using a biometric scanner as an electronic signature for a loan agreement and/or other investment authentication. Further, various verification keys can be generated and delivered to a user via email, phone call, and/or text message. A user can use the verification key to securely sign the loan agreement and/or other investment authentication.

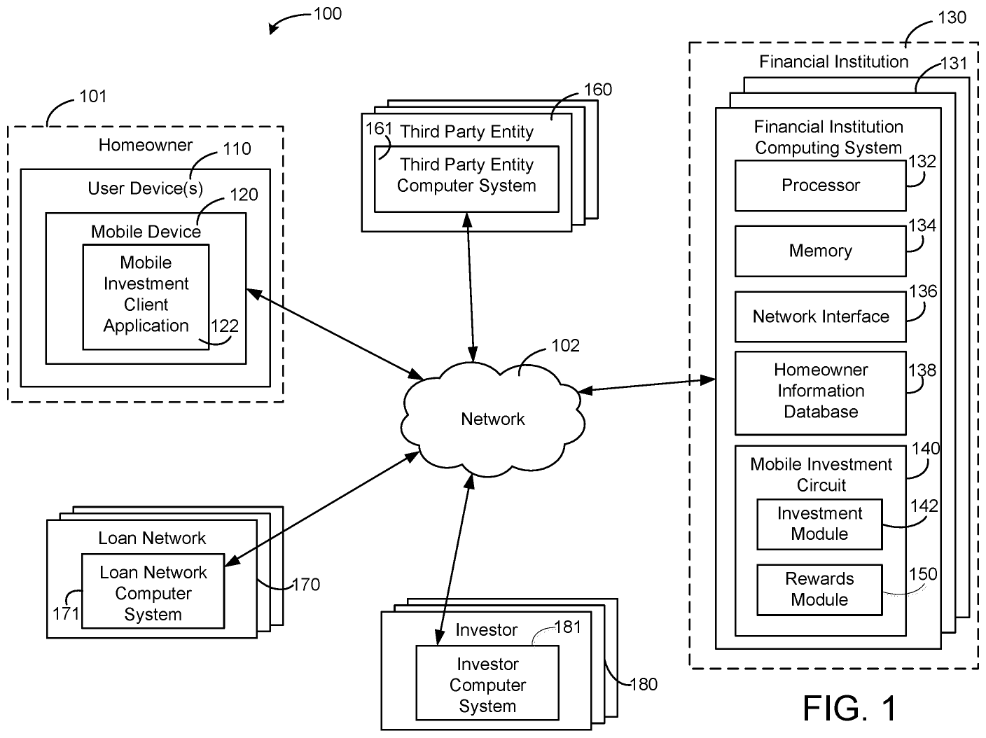

Referring now to FIG. 1, a block diagram of a computing system 100 is shown, according to an example embodiment. As described herein, the computing system 100 may facilitate the participation of a homeowner (e.g., homeowner 101) in one or more investment opportunities. As used herein, “investments” refers to stocks, bonds, loans, peer-to-peer loans, and/or any other action or process of investing money. In this regard and as used herein, “investment opportunities” refers to opportunities to enroll or participate in at least one of the aforementioned investments. It should be understood that the aforementioned list is not meant to be exhaustive as the present disclosure contemplates more and other investment opportunities, which are all intended to fall within the spirit and scope of the present disclosure. As described herein below, computing system 100 can facilitate the investment opportunities in a secure manner. In various embodiments, biometric scanners and verification keys can be utilized by various components, systems, and devices of system 100 to securely facilitate the investment opportunities by authenticating and confirming the identity of users before enabling participation in the selected investment opportunities.

Referring more particularly to FIG. 1, the computing system 100 is shown to include one or more user device(s) 110 associated with a homeowner 101, one or more financial institution(s) 130 having an associated financial institution computing system 131, one or more third party entities 160 associated with a third party entity computer system 161, one or more loan networks 170 associated with a loan network computer system 171, and one or more investors 181 associated with an investor computer system 181. In some embodiments, investors 181 and loan network 170 and their respective computing systems can be a single entity and can be referred to collectively as “investors,” as used herein. In other embodiments, like shown, the investors 181 and loan network 170 may be separate entities with their own respective computing systems.

The components of FIG. 1 may be communicably and operatively coupled to each other over a network 102. The network 102 may be any type of network or combination of networks. For example, the network 102 may be a wireless network interface (e.g., 802.11X, ZigBee, Bluetooth, Internet, etc.), a wired network interface (e.g., Ethernet), or any combination thereof. In various embodiments, the network 102 includes a proprietary banking network to provide secure or substantially secure communications which reduce the threat of hacking. The network 102 may be structured to permit the exchange of data, values, instructions, messages, and the like between and among the user device 110, the financial institution computing system 131, the third party entity computer system 161, the loan network computer system 171, and the investor computer system 181. More than one financial institution 130 with an associated financial institution computing system 131 may be communicably coupled to the components of FIG. 1 over the network 102 to include accounts held by the homeowner 101 with two or more financial institutions.

As shown, the financial institution 130 includes a financial institution computing system 131. The financial institution computing system 131 includes a processor 132, a memory device 134, a network interface 136, a homeowner information database 138, and a mobile investment circuit 140. The processor 132 may be implemented as a general-purpose processor, an application specific integrated circuit (ASIC), one or more field programmable gate arrays (FPGAs), a digital signal processor (DSP), a group of processing components (e.g., a server arrangement), or other suitable electronic processing components. The one or more memory devices 134 (e.g., RAM, ROM, NVRAM, Flash Memory, hard disk storage, etc.) may store data and/or computer code for facilitating at least some of the various processes described herein. In this regard, the memory device 134 may store programming logic that, when executed by the processor 132, performs at least some operations of the financial institution computing system 131.

The network interface 136 facilitates the sending and receiving of data over the network 102 (e.g., to and from the user device 110, the third party entity computer system 161, the loan network computer system 171, the investor computer system 181, etc.). Network interface 136 can send instructions and commands to loan network computer system 170 and/or investor computer system 181, which facilitate the participation in various investment opportunities. In some embodiments, network interface 136 can be configured to send a verification code to one or more devices (e.g., mobile device 120) in the system 100 via a message. The message may be a phone call, send a text message, and/or send an email which includes the verification key. In various embodiments, a loan agreement can be electronically signed on a mobile device 120 (e.g., mobile device 120) via the verification code.

In some embodiments, network interface 136 can receive data relating to homeowner 101 from mobile device 120 and store the data in homeowner information database 138. Homeowner information database 138 can store homeowner information and account information relating to accounts held with the financial institution 130 of the homeowner 101. The homeowner information database 138 may communicate homeowner information to various components of financial institution computing system 131 (e.g. mobile investment circuit 140). In some embodiments, the homeowner information database 138 may be a non-volatile storage medium such as ROM, flash memory (e.g., flash memory such as NAND, 3D NAND, NOR, 3D NOR, etc.), EEPROM, MRAM, magnetic storage, hard discs, optical discs, etc. In another embodiment, the homeowner information database 138 may be a volatile storage medium such as RAM, TRAM, ZRAM, etc.

As shown in FIG. 1, the financial institution computing system 131 includes a mobile investment circuit 140. The mobile investment circuit 140 may be configured to retrieve homeowner information from the homeowner information database 138. The information may include at least one of the equity value of a home of homeowner 101, information regarding the mortgage payments of homeowner 101, the investment risk the homeowner 101 is willing to engage in, an address of the property subject to the loan, terms of the loan, social security and other personal information regarding the homeowner, title insurance information, rewards preferences, spending history, account balances, etc. The mobile investment circuit 140 may identify investment opportunities for homeowner 101 by communicating with various entities offering investment opportunities. Upon approval by the homeowner 101 to engage in various selected investment opportunities, the mobile investment circuit 140 may facilitate the enrollment with the selected investment opportunities with the various entities by using the equity value of the home associated with homeowner 101. The mobile investment circuit 140 may generate income based on participation in the selected investment opportunities based on the equity of the home of homeowner 101.

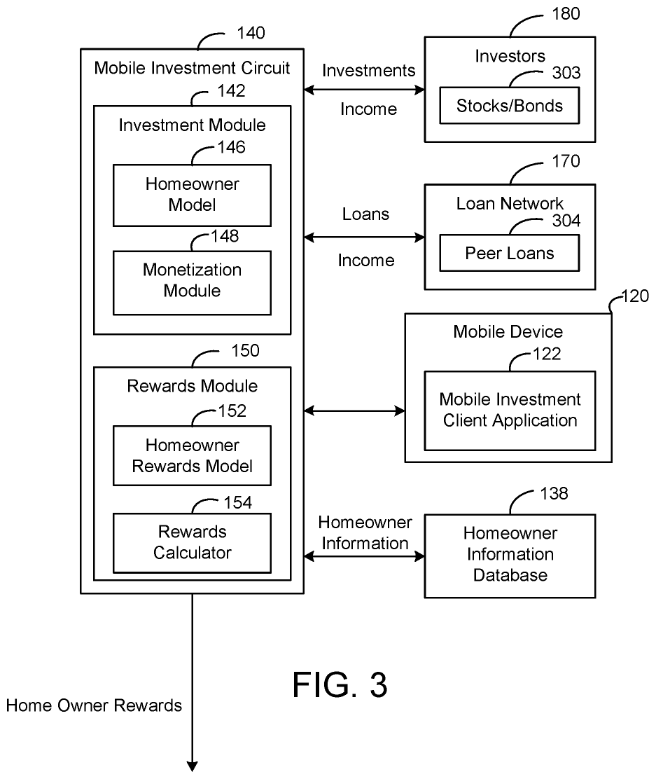

Mobile investment circuit 140 is shown to include an investment module 142 and a rewards module 150. Mobile investment circuit 140 can use investment module 142 to select the investment opportunities applicable for homeowner 101 and facilitate participation in the selected investment opportunities. Mobile investment circuit 140 can use rewards module 150 to provide rewards to homeowner 101. While only two modules are depicted, it should be understood that more or fewer modules may be utilized by mobile investment circuit 140 in other embodiments without departing from the spirit and scope of the present disclosure. The structure and activities of the investment module 142 and rewards module 150 are explained in more detail herein with respect to FIG. 3.

Mobile investment circuit 140 may match the homeowner 101 with investment opportunities offered by loan network 170 and/or investor computer system 181. The factors used by mobile investment circuit 140 to match homeowner 101 with investment opportunities may include, but are not limited to, the equity value associated with the home of homeowner 101, the expected return of the investment, and the investment risk that the homeowner 101 and the financial institution 130 are willing to engage in, etc. In some embodiments, the loan network 170 and/or financial institution 130 may match the homeowner 101 with secured or unsecured loans that are being requested by individuals referred to as “loan requestors” herein. In various embodiments, mobile investment circuit 140 can match homeowner 101 with stocks or bonds offered by investors 181.

In some embodiments, mobile investment circuit 140 can cause the investor 180 and/or loan network 170 to make investments based on directions, instructions, commands, messages, and the like. The mobile investment circuit 140 may ask, request, or otherwise instruct the investor computer system 181 to perform a plurality of investment activities with the equity value associated with the home of the homeowner 101. The investment opportunities may include, but are not limited, to stocks, bonds, loans, peer-to-peer loans, and/or any other action or process of investing money. The appropriate combination and amount of investments may be determined by the investment module 142 of the financial institution computing system 131.

The computing system 100 may also include one or more third party entities 160. Third party entity 160 may be an individual, a group of individuals, a loan officer, and/or any other entity providing or overseeing a loan opportunity and/or other investment opportunity to homeowner 101. The third party entity computer system 161 may be one or a plurality of computer systems. The computer systems may include, but are not limited to, a desktop computer, a smartphone, a laptop, and a tablet. The third party entity computer system 161 is connected via the network 102 to the mobile investment client application 122 and the financial institution computing system 131. Upon approval by the homeowner 101 on the mobile investment client application 122 of a selected investment opportunity offered by third party entity 160, the third party entity 160 may receive a notification on the third party entity computer system 161 and may be prompted to approve or reject the selected investment opportunity.

As shown, computing system 100 includes homeowner 101. Homeowner 101 may include individuals, business representatives, large and small business owners, and any other entity who owns a home. In some configurations, the homeowner 101 may have a financial account at one or more of the financial institution(s) 130 of the system 100. Homeowner 101 is associated with user device 110. User device 110 may be generally described as a mobile device 120. The mobile device 120 may include any wearable device. Wearable devices refer to any type of device that a user wears including, but not limited to, a watch (e.g., a smart watch), smart glasses (e.g., smart eye glasses, smart sun glasses, etc.), bracelet (e.g., a smart bracelet), etc. Mobile device(s) 120 may also include any type of mobile device of a homeowner 101 including, but not limited to, a phone (e.g., a smartphone, etc.) and a computing device (e.g., a tablet computer, a laptop computer, a person digital assistant, etc.). Accordingly, the user device 110 may include a display device (e.g., a screen) and one or more input/output devices (e.g., a touch screen, microphone, speaker, keyboard, etc.).

In this example, the user device 110 includes a mobile investment client application 122. The mobile investment client application 122 may be a server-based application executable on the user device 110. In this regard, a user may have to first download the application prior to its usage. In another embodiment, the mobile investment client application 122 may be hard coded into the memory of the user device 110. In still another embodiment, the mobile investment client application 122 may be a web-based interface application. In this configuration, the user may have to log onto or access the web-based interface before usage of the applications. In this regard, the mobile investment client application 122 may be supported by a separate computing system comprising one or more servers, processors, network interface modules, etc. that transmit the application for use to the user device 110. In certain embodiments, the mobile investment client application 122 may include an application programming interface (API) and/or a software development kit (SDK) that facilitate the integration of other applications with the mobile investment client application 122. All such variations and combinations are intended to fall within the spirit and scope of the present disclosure.

The mobile investment client application 122 may be communicably coupled to the financial institution computing system 131 and/or the homeowner information database 138 via the network 102 and may be structured to permit management of the accounts of the homeowner 101 via the mobile investment client application 122. In this regard, the mobile investment client application 122 may provide displays indicative of current account balances, pending transactions, profile information (e.g., contact information), applicable loans, applicable investments, mortgage information and the like. Further, in some embodiments, the mobile investment client application 122 may also permit payments from the homeowner 101 to a designated recipient and/or payments from the designated recipient to the homeowner 101. For example, the mobile investment client application 122 may depict a loan of a user (e.g., mortgage) and allow the user to pay the mortgage from one of their accounts (e.g., checking or savings). Further, in some embodiments, the mobile investment client application 122 may provide the user with an investment opportunity from loan network 170 and/or investors 181. The mobile investment client application 122 may prompt the user to either accept or reject an investment.

In some embodiments, mobile investment client application 122 can perform some and/or all of the functions of mobile investment circuit 140 and/or financial institution computing system 131. To perform the functions of mobile investment circuit 140, mobile investment client application 122 can communicate with financial institution computing system 131 via network 102 to retrieve any information that mobile investment circuit 140 would otherwise retrieve from financial institution computing system 131. Further, mobile investment client application 122 can send any commands, messages, and the like to financial institution computing system 131 to perform the functions of mobile investment circuit 140.

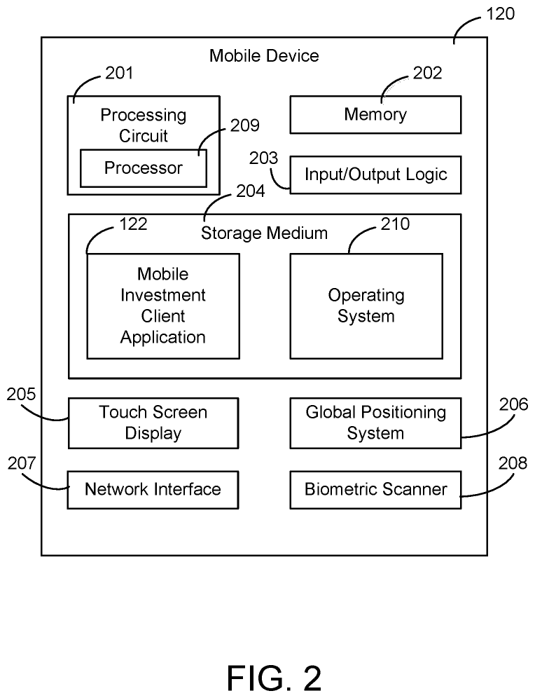

Referring now to FIG. 2, the function and structure of the mobile device 120 with the mobile investment client application 122 is shown in greater detail according to an example embodiment. In the example depicted, the mobile device 120 includes a processing circuit 201 having a processor 209, a memory device 202, a touch screen display 205, a global positioning system 206, a network interface 207, a biometric scanner 208 and an operating system 210. While various circuits, interfaces, and logic with particular functionality are shown, it should be understood that the mobile device 120 may include any number of circuits, interfaces, and logic for completing the functions described herein. For example, the activities of multiple circuits may be combined as a single circuit, as additional circuits with additional functionality may be included, etc.

The processor 209 may be implemented as a general-purpose processor, an application specific integrated circuit (ASIC), one or more field programmable gate arrays (FPGAs), a digital signal processor (DSP), a group of processing components, or other suitable electronic processing components. The one or more memory devices 202 (e.g., RAM, NVRAM, ROM, Flash Memory, hard disk storage, etc.) may store data and/or computer code for facilitating the various processes described herein. Moreover, the one or more memory devices 202 may be or include tangible, non-transient volatile memory or non-volatile memory. Accordingly, the one or more memory devices 202 may store database components, object code components, script components, or any other type of information structure for supporting the various activities and information structures described herein.

The input/output logic 203 may be structured to receive and provide communication(s) to homeowner 101 of the mobile device 120 (or, to another entity such as the financial institution computing system 131). In this regard, the input/output logic 203 may be structured to exchange data, perform communications, exchange instructions, etc. with an input/output component of the mobile device 120. Accordingly, in one embodiment, the input/output logic 203 may include an input/output device such as a touch screen display (e.g., touch screen display 205), a keyboard, a speaker, and a microphone. In another embodiment, the input/output logic 203 may include communication circuitry for facilitating the exchange of data, values, messages, and the like between an input/output device and the components of the user device 110. In yet another embodiment, the input/output logic 203 may include machine-readable media for facilitating the exchange of information between the input/output device and the components of the user device 110. In still another embodiment, the input/output logic 203 may include any combination of hardware components (e.g., a touchscreen), communication circuitry, and machine-readable media.

Storage medium 204 is configured to store the mobile investment client application 122 and the operating system 210. In various embodiments, storage medium 204 is a non-transitory storage medium communicating with memory 202 to execute the various functions and processes stored in storage medium 204 on processor 209. In this regard, storage medium 204 may be a hard disk that can load programs and other information into memory 202 for processing. In some embodiments, processing circuit 201 may command storage medium 204 to load at least one of mobile investment client application 122 and operating system 210 into memory device 202. In some embodiments, processing circuit 201 may command storage medium 204 to store data which it calculates or receives (e.g. receives from touch screen display 205, network interface 30, global positioning system 206, etc.). In some embodiments, storage medium 204 includes non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media which storage medium 204 may include.

Touch screen display 205 may be configured to receive an input from the homeowner 101 and, in response, to display information to the homeowner 101 (e.g. mobile investment client application 122). In some embodiments, touch screen display 205 is a resistive touch screen and/or a capacitive touch screen. In some embodiments, touch screen display 205 includes a plurality of layers. Some layers may be used to display output while other layers are configured to receive inputs. In some embodiments, some of the layers are electrically-resistive layers. A touch to one of the layers creates a connection between two of the layers and the touch screen display 205 can identify the location of the touch from based on the voltage applied to one of the layers and the voltage sensed by another of the layers. In some embodiments, one of the layers is coated with a transparent conductor that homeowner 101 can touch. In some embodiments, touching the transparent conductor will result in a change in the electrostatic field of touch screen display 205. In some embodiments, the change is measureable as a change in capacitance and can be used to identify the location of touch screen display 205 that homeowner 101 has touched.

Global positioning system 206 is configured to determine the location of mobile device 120. In some embodiments, the global positioning system 206 receives a broadcast signal from a plurality of satellites. The global positioning system 206 may receive a pseudorandom code from each of the satellites which global positioning system 206 is preconfigured to store. The global positioning system 206 may be configured to calculate a time of arrival from the pseudorandom code from each of the satellites. The global positioning system 206 may also be configured to receive a message that includes time of transmission from each of the satellites. In some embodiments, the global positioning system 206 uses the time of arrival and the time of transmission from each of the satellites to compute a time of flight. The global positioning system 206 may use the time of flight values to determine a three dimensional position of the global positioning system 206. Further, global positioning system 206 may communicate the three dimensional position to the processing circuit 201. Processing circuit 201 may use the three dimensional position and a known map to identify stores, businesses, and other common locations that homeowner 101 visits on a regular basis. The stores, businesses, and/or other common locations that homeowner 101 visits on a regular basis may be communicated to financial institution computing system 131.

The network interface 207 is structured to establish a communication session via the network 102 with at least one of the financial computing system 131, the third party entity computer system 161, the loan network computer system 171, and the investor computer system 181. Accordingly, the network interface 207 includes any of a cellular transceiver (e.g., CDMA, GSM, LTE, etc.), a wireless network transceiver (e.g., 802.11X, ZigBee, Bluetooth, etc.), or a combination thereof (e.g., both a cellular transceiver and a Bluetooth transceiver). Further, the network interface 207 may include a wired connection (e.g. Ethernet). Further, the network interface 207 may include cryptography capabilities to establish a secure or relatively secure communication session with the at least one financial institution computing system 131 or another device of the user's choosing (e.g., the third party entity computer system 161). In this regard, data may be encrypted to prevent or substantially prevent the threat of hacking.

Biometric scanner 208 is structured to receive a human fingerprint and provide the fingerprint to processing circuit 201 for pattern matching recognition between a known human fingerprint and a fingerprint received from biometric scanner 208. In some embodiments, the biometric scanner 208 is an optical fingerprint scanner. The biometric scanner 208 may be configured to capture a digital image of a fingerprint using visible light. In some embodiments, the biometric scanner 208 is an ultrasonic sensor. The ultrasonic sensor may use high frequency sound waves to determine a visual image of a fingerprint based on the sound waves that are reflected by the dermal skin layer of the finger. In some embodiments, the biometric scanner 208 is at least one of a passive capacitance sensor and an active capacitance sensor. A passive capacitance sensor may create a visual image of a fingerprint based on capacitance variances between ridges and valleys of the finger. An active capacitance sensor may use a charging cycle to apply a voltage to the dermal layer of a finger and then use an electric field between the finger and the sensor to identify the pattern of ridges of the fingerprint.

Processing circuit 201 may be configured to perform pattern-matching algorithms to compare an image of an unknown fingerprint determined by biometric scanner 208 to a known fingerprint. The pattern matching algorithm may compare basic fingerprint patters (e.g. arch, whorl, and/or loop) between known fingerprint and the unknown fingerprint. The processing circuit 201 may be configured to graphically compare the known fingerprint and the unknown fingerprint and determine a degree to which they match. If the degree to which the unknown fingerprint and the known fingerprint match passes a threshold the processing circuit 201 may determine that the known fingerprint is the unknown fingerprint. In some embodiments, the threshold is a percentage (e.g. 90% match, 95% match, etc.). The percentage may be any value or range of values that the financial institution 130 defines as acceptable or the developers of mobile device 120 define as acceptable. In various embodiments, a match and/or the degree to which the unknown fingerprint and the known fingerprint match may be sent to financial institution computing system 131.

Operating system 210 is stored on storage medium 204 and may be code run on processing circuit 201. In some embodiments, the operating system 210 is native to the mobile device 120. The operating system 210 may be an operating system such as Android and/or iOS. In some embodiments, the operating system is a custom operating system. In some embodiments, the operating system has been approved by financial institution 130. In some embodiments, the operating system 210 is configured to run mobile investment client application 122. In some embodiments, mobile investment client application 122 may run independently of operating system 210.

Turning now to the mobile investment client application 122, the mobile investment client application 122 is structured to communicate with financial institution computing system 131 (i.e., mobile investment circuit 140, homeowner information database 138, etc.). In this regard, mobile investment client application 122 can communicate various preferences regarding investment opportunities and rewards to financial institution computing system 131. For example, the mobile investment client application 122 may allow a user to send reward preferences to financial institution computing system 131 (e.g., homeowner information database 138). The preferences indicated by mobile investment client application 122 may include, but are not limited to, payment of a grocery bill, payment of a utility bill, repayment of a mortgage, repayment of a loan, and/or any other reward. Based on communication with mobile investment client application 122, financial institution computing system 131 may be configured to credit various accounts of homeowner 101 for reimbursement of utility bills and/or grocery bills with the revenue generated by investments of the home equity of homeowner 101 based on the preferences. Also, mobile client application 122 can cause financial institution computing system 131 to automatically make payments for a mortgage and/or loan of homeowner 101 based on the revenue generated by investments and/or the number of mortgage payments made within a predefined amount of time. Mobile client application 122 may be configured to display a notification to homeowner 101 on touch screen display 205 which may include a message confirming that rewards have been received (i.e., credited, reimbursed, etc.), the amount of the rewards, the amount of revenue generated from various investments, and/or any other information.

In various embodiments, mobile client application 122 may receive selected investment opportunities from mobile investment circuit 140. In some embodiments, the selected investment opportunity may be displayed on touch screen display 205 and may allow homeowner 101 to approve one or more of the selected investment opportunity. Responsive to homeowner 101 approving the selected investment opportunity, mobile investment circuit 140 may send a message to mobile investment circuit 140 indicating the homeowner 101 has approved one or more of the selected investment opportunities. Mobile investment client application 122 can generate an investment opportunity agreement for the selected and approved investment opportunities for homeowner 101 to digitally sign. In some embodiments, the selected investment opportunity is a loan (e.g., a peer-to-peer loan). When the selected investment opportunity is a loan, mobile investment client application 122 and/or mobile investment circuit 140 can generate a loan agreement. Mobile investment circuit 140 can cause the loan agreement to be displayed on touch screen display 205. The loan agreement may include the amount of home equity being loaned, approximate revenue generated from the loan, terms of the agreement, and/or any other information. A user (e.g., homeowner 101) may be able to accept and/or reject the loan via touch screen display 205. Data including accepting or rejecting the loan may be sent to at least one of the third party entity computer system 161 and financial institution computing system 131.

Verifying acceptance or rejection of the investment opportunity may be performed by an authorized individual (i.e., homeowner 101). Additionally, various security measures can be performed by mobile investment client application 122. For example, an agree or a decline button corresponding to accepting or rejecting a loan agreement or investment opportunity agreement may be locked (i.e., inactive) until homeowner 101 is authenticated. In some embodiments, an investment opportunity agreement (e.g., the loan agreement) generated by mobile investment client application 122 requires a user to authenticate via a biometric scanner. Mobile investment client application may store a known fingerprint of homeowner 101 and may utilize processor 209 to perform pattern matching between the known fingerprint and a scanned fingerprint. If the fingerprint match is above a predefined amount (e.g., a match percentage), mobile investment client application 122 may allow homeowner 101 to accept the investment opportunity. Further, mobile investment client application 122 may use the fingerprint and/or the fingerprint match as the digital signature for the investment opportunity agreement and can send a notification of the fingerprint match or an image of the fingerprint input by homeowner 101 to financial institution computing system 131, investor computer system 181, and/or loan network computer system 171.

Mobile investment client application 122 can utilize a verification key to electronically sign the investment opportunity or authenticate homeowner 101 in place of, or in addition to, the fingerprint matching. In various embodiments, homeowner 101 can register various email addresses and/or phone numbers with mobile investment client application 122 and financial institution computing system 131. Mobile investment client application 122 can allow homeowner 101 to select an email and/or phone number and specify a verification key be sent to the email address via email and/or to the phone number via phone call and/or text. The phone call and/or text may contain a verification key such as a random alphanumeric value. Mobile investment client application 122 may require homeowner 101 to enter the verification key via touch screen display 205, before homeowner 101 accepts or rejects the investment opportunity agreement. Further, the verification key may be used by mobile investment client application 122 as an electronic signature.

Referring now to FIG. 3, a diagram of the mobile investment circuit 140 is shown in greater detail, according to an exemplary embodiment. Mobile investment circuit 140 is structured to identify investment opportunities for homeowner 101 and to identify and facilitate investment opportunities for homeowner 101. In various embodiments, mobile investment circuit 140 is configured to use the equity value of a home of homeowner 101 to identify various investment opportunities. Further, mobile investment circuit 140 can cause a mobile device (i.e., mobile device 120) associated with homeowner 101 to generate an investment opportunity agreement (e.g., a loan agreement). Mobile investment circuit 140 can be configured to provide secure user authentication and digital document signing with fingerprint matching or verification keys as described in FIG. 2 and elsewhere herein.

Mobile investment circuit 140 is shown to communicate to loan network 170, investors 180, mobile investment client application 122 of mobile device 120, and/or homeowner information database 138. Mobile investment circuit 140 is shown to include investment module 142. Investment module 142 can be structured to identify investment opportunities for homeowner 101 and facilitate participation in the investment opportunities. By using the equity value associated with a home of homeowner 101, investment module 142 can be configured to select one or more investment opportunities from the plurality of investment opportunities offered by the various entities.

Investment module 142 is shown to include homeowner model 146 and monetization module 148. Homeowner model 146 can be a database or storage medium including relevant investment parameters for a homeowner (e.g., homeowner 101). The parameters can be any relevant information needed to select investment opportunities for the homeowner. In some embodiments, the parameters of homeowner model 146 can be an equity value of a home of the homeowner, investment preferences of the homeowner, mortgage payment history of the homeowner, mortgage term, remaining mortgage term, the amount of risk homeowner 101 prefers for investment opportunities such as high risk, medium risk, low risk, etc. Homeowner model 146 can be configured to retrieve the various homeowner parameters or preferences from homeowner information database 138. For example, homeowner model 146 could receive risk tolerance from mobile device 120. The risk tolerance may be the amount of investment risk that homeowner 101 would like to engage in. In some embodiments, investment module 142 may be configured to create and/or update homeowner model 146.

In some embodiments, monetization module 148 may use the various parameters of homeowner model 146 to select investment opportunities. For example, monetization module 148 may identify investment opportunities based on an equity level. If the equity level is above a predefined threshold, relatively more risky investment opportunities, such as peer-to-peer loans, may be identified as investment opportunities for homeowner 101. If the equity level of homeowner 101 is not above the predefined threshold, the homeowner 101 may not be eligible for those more risky investment opportunities. Instead, the homeowner may be eligible for only certain less risky investment opportunities. For example, if the equity value of homeowner 101 is at or above a predefined amount, the homeowner 101 may be eligible for peer-to-peer loans, stocks, and/or bonds but when the equity value is below the predefined amount, the homeowner 101 may only be eligible for stocks and/or bonds. Further, monetization module 148 can select investment opportunities based on the remaining mortgage term. For example, when the remaining mortgage term is at or below a predefined amount, monetization module 148 can be configured to select peer-to-peer loans as the investment opportunities. When the remaining mortgage term is above a predefined amount, monetization module 148 can be configured to select stocks and bonds as the investment opportunities.

Monetization module 148 can be configured to use investment risk to identify investment opportunities. “Investment risk” may be a numerical value, a percentage, and/or any other representative of the amount of risk homeowner 101 is willing to accept for various investment opportunities. If the investment risk is above a predefined amount, monetization module 148 may select loans (e.g., peer-to-peer loans) as the investment opportunity. If the investment risk is below the predefined amount, monetization module 148 can be configured to select stock and/or bond investments. For example, the investment risk homeowner 101 is willing to engage in is 70%, the investment risk of a peer-to-peer loan is 90%, and the investment risk of a bond is 20%. Based on the risk homeowner 101 is willing to engage in, monetization module 148 may not select the peer-to-peer loan for homeowner 101 since the risk value associated with the peer-to-peer loans is greater than the risk homeowner 101 is willing to engage in. Monetization module 148 may select the bond for homeowner 101 since the risk homeowner 101 is willing to engage in is above the risk level for the bond.

In some embodiments, when the identified investment opportunities are loans, monetization module 148 can be configured to communicate with financial institutions 130 to identify a credit score of an individual (e.g., third party entity 160) requesting a loan (i.e., “loan requestor”), an annual income of the loan requestor, asset(s) of the loan requestor (e.g., businesses, homes, automobiles, etc.), the collateral the loan requestor is offering, the job security of the loan requestor, and/or any other relevant information regarding the loan requestor. When the credit score, income, or other information is above a predefined amount, the loan may be applicable for homeowner 101. If the credit score, income or other information is not above the predefined amount, the loan requestor may not be considered for a loan.

The investment opportunities which monetization module 148 selects can be sent to mobile investment client application 122 for approval. If homeowner 101 approves the investment opportunities identified by monetization module 148, monetization module 148 can be configured to facilitate the investments with investors 180, loan network 170, or seek a secondary verification from third party entity 160 via third party entity computer system 161 before facilitating the investments. In various embodiments, security measures are facilitated by investment module 142 to authenticate homeowner 101 and approve investment opportunities. Investment module 142 may facilitate the investment opportunities after one or more authentication and verification processes have been performed.

Responsive to homeowner 101 accepting one or more of the selected investment opportunities, mobile device 120 may generate an investment opportunity agreement which requires a digital signature (i.e., authentication and verification). In various embodiments, the digital signature is a verification code or a fingerprint image. The mobile device 120 and/or the investment opportunity agreement may require homeowner 101 to enter a fingerprint. Mobile device 120 can match the entered fingerprint to a known fingerprint stored on mobile device 120. The level at which the entered fingerprint and the known fingerprint match may be sent to investment module 142. Investment module 142 may facilitate the investment opportunities if the match level is above a predefined amount. Further, investment module 142 may receive a request from mobile device 120 to generate a verification code. Investment module 142 can be configured to randomly (i.e., pseudo-randomly) generate and/or select an alphanumeric value. In various embodiments, the request to generate the verification key includes a communication means (e.g., text message, phone call, email) and a phone number or email address selection. In various embodiments, investment module 142 stores registered phone numbers and email addresses. The alphanumeric value can be received via the text message, phone call, and/or email. Homeowner 101 may enter the verification key via the touch screen display 205 of mobile device 120. Mobile device 120 can send the entered verification key to mobile investment circuit 140. Mobile investment circuit 140 can match the entered verification key to the selected or generated verification key. If the keys match, the mobile investment circuit 140 may confirm that the homeowner 101 has been successfully authenticated and verified.

Still referring to FIG. 3, rewards module 150 is shown to receive homeowner information and determine homeowner rewards. “Homeowner rewards” may be any monetary reward that can be provided to homeowner 101. The rewards may be a gift card, paying a portion of a loan of homeowner 101, paying a utility bill of homeowner 101, etc. Rewards module 150 includes homeowner rewards model 152 and rewards calculator 154. Rewards module 150 may be configured to receive the homeowner information from homeowner information database 138 and may be configured to create and/or update homeowner rewards model 401. Based on the information stored in homeowner rewards model 401, the rewards module 150 can select one or more rewards for homeowner 101. Homeowner rewards model 152 may be or include a database and/or any other memory structure. Homeowner rewards model 152 may be configured to store various rewards preferences or information regarding rewards preferences of homeowner 101. The preferences of homeowner 101 may include paying utilities, paying groceries, paying day-to-day expenses, and/or paying off loans and/or debt. Further, the homeowner rewards model 152 may store current deals which the financial institution 130 has with businesses, service providers, etc.

In one embodiment, the “current deals” may be agreements which the financial institution has with various businesses, service providers, etc. to make purchases from them for reduced costs. Rewards calculator 154 may be configured to identify ideal rewards for the homeowner 101 based on homeowner rewards model 152. Any method for determining ideal rewards for the homeowner 101 may be used. In some embodiments, the rewards module 150 serves a notification to the homeowner 101 via the mobile device 120 asking the homeowner if the homeowner wants the identified rewards. In some embodiments, the rewards module 150 may serve a notification to the homeowner 101 via the mobile device 120 which presents multiple possible rewards for the homeowner 101 and prompts the homeowner to select at least one of the rewards. For example, the notification may include one or more rewards associated with ongoing deals which the financial institution 130 has with businesses, service providers, etc. The notification may allow homeowner 101 to select one or more of the ongoing deals.

In some embodiments, rewards calculator 154 monitors the mortgage payments of homeowner 101. If homeowner 101 has made a predefined amount of mortgage payments on time and/or within a predefined amount of time, the rewards calculator 154 can be configured to serve a reward to homeowner 101 and/or notify homeowner 101 via mobile device 120 and/or mobile investment client application 122 that homeowner 101 is eligible for a reward. If homeowner 101 is eligible for a reward, homeowner 101 may be able to select a reward via mobile investment client application 122. The reward may be a remission of part and/or all of a mortgage. For example, if a homeowner has made a predefined amount of mortgage payments on time within a certain period of time, the homeowner 101 may be eligible for a remission of some or all of the mortgage. In one embodiment, when mobile device 120 performs the functionality of mobile investment circuit 140, mobile device 120 may communicate with the financial institution computing system 131 to identify the number of mortgage payments made within a predefined amount of time. Financial institution computing system 131 may send the number of mortgage payments made within the predefined amount of time directly to mobile device 120.

The rewards may be paid by crediting one or more financial accounts of homeowner 101 with a refund and/or deposit and/or may be sent a gift card. Further, rewards module 150 may be configured to forego and/or remit part and/or all of a loan and/or mortgage of homeowner 101. The rewards may be generated from the revenue from the various loans and/or investments which monetization module 148 facilitates. When rewards module 150 cause a reward to be served to homeowner 101 (i.e., crediting an account, forgoing a portion of a loan and/or mortgage) a notification may be sent to mobile device 120 which notifies the homeowner 101 that they have received the reward.

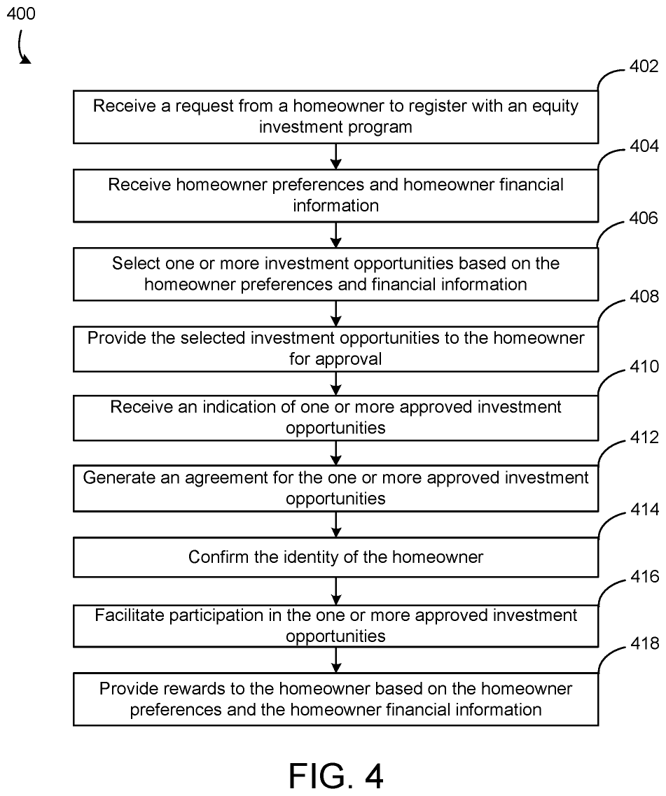

Referring now to FIG. 4, a process 400 for monetizing home equity is shown, according to an example embodiment. Process 400 can be implemented by the mobile investment circuit 140 of financial institution computing system 131 and/or by mobile investment client application 122 of mobile device 120. In this regard, mobile investment client application 122 can embody and/or perform any and all processes of mobile investment circuit 140. For this reason, reference may be made to various components of computing system 100 in general to aid in the explanation of process 400.

At process 402, mobile investment circuit 140 receives a request from homeowner 101 to register with an equity investment program. In some embodiments, registering for the equity investment program may authorize financial institution 130 to invest the equity of homeowner 101 or a portion thereof, and provide rewards to homeowner 101 for paying mortgage bills on time. The registration process may include mobile investment client application 122 prompting homeowner 101 to enter preferences, enter financial information, sign legal agreements, and/or any other action for registering for the equity investment program via touch screen display 205.

In various embodiments, individuals who do not have equity, a sufficient amount of equity, or do not wish to invest their equity, may still register for the equity investment program. These individuals may register in order to be matched with homeowners (e.g., homeowner 101) offering their equity in the form of a loan or another investment opportunity. In some embodiments, homeowner 101 can perform the registration process via mobile investment client application 122 on mobile device 120. These individual may be added by mobile investment circuit 140 to a pool of aggregated investment opportunities. Mobile investment circuit 140 may generate and maintain the pool of all possible investment opportunities. Mobile investment circuit 140 may communicate with loan network 170, third party entity 160, investor 180, other financial institutions offering investment opportunities. Mobile investment circuit 140 may further generate the pool of aggregated investment opportunities to include individuals holding accounts with financial institution 130 and/or any other financial institution who may wish to receive the equity of homeowner 101 as a loan. The investment opportunities offered by these, and any other entity, may be aggregated into one or more pools for mobile investment circuit 140 to select investment opportunities or homeowner 101.

At process 404, mobile investment circuit 140 receives homeowner preferences and financial information associated with homeowner 101. In some embodiments, mobile investment circuit 140 receives the information when the homeowner 101 registers for the equity investment program as described at process 402. In some embodiments, the financial institution computing system 131 may be configured to retrieve the information from one or more accounts that homeowner 101 may have with financial institution 130. The accounts may be a mortgage agreement, a bank account, a credit card account, and/or any other account. In some embodiments, the financial institution computing system 131 may run database or internet searches based on the information provided by the homeowner 101 during registration to retrieve information relating to homeowner 101. In some embodiments, information regarding homeowner 101 may be collected from social networks such as LINKEDIN®, FACEBOOK®, TWITTER®, and/or any other social network.

The preferences may include a preferred risk value (i.e., the amount of investment risk the homeowner 101 is willing to engage in). In some embodiment, the preference is a preferred investment opportunity. The preferred investment opportunity may be an investment opportunity which homeowner 101 is interested in. For example, homeowner 101 may have a preferred investment opportunity of stocks. In this example, mobile investment circuit 140 may only or may more frequently select stocks for homeowner 101. In some embodiments, the preferred risk is a percentage where 0% risk may indicate minimal and/or no investment risk while 100% may indicate high investment risk. The metric may also be a value on a linear scale (i.e., 0-10 scale). In various embodiments, the metric is a predefined level that homeowner 101 can select such as “Minimal Risk”, “Low Risk”, “Moderate Risk”, or “High Risk.” For example, the investment risk homeowner 101 is willing to engage in is 70%, the investment risk of a peer-to-peer loan is 90%, and the investment risk of a bond is 20%. Based on the risk homeowner 101 is willing to engage in, homeowner 101 may not eligible for the peer-to-peer loan for homeowner 101 since the risk value associated with the peer-to-peer loans is greater than the risk homeowner 101 is willing to engage in. Further, homeowner 101 may be eligible for the bond since the risk homeowner 101 is willing to engage in is above the risk level for the bond.

The financial information may include, but is not limited to a, social security number, legal name, date of birth, address, one or more bank account numbers, one or more mortgage identification numbers (MIN) (i.e., a unique numeric or alphanumeric value that is associated with the mortgage of the homeowner), a taxpayer identification number (TIN), and an equity value associated with a property of the homeowner, mortgage payment information of homeowner 101, and/or any other information. In some embodiments, the information includes the spending habits of homeowner 101. The spending habits of homeowner 101 may include favorite stores, favorite restaurants, and/or favorite online retailors of the homeowner 101.

Mobile investment circuit 140 may receive favorite stores, restaurants, and/or online retailors of homeowner 101 from mobile investment client application 122. In some embodiments, a credit card bill is analyzed by the financial institution computing system 131 to identify the frequented (i.e., favorite) stores, restaurants, and/or online retailors of the homeowner 101. In some embodiments, mobile investment circuit 140 and/or mobile investment client application 122 uses global positioning system 206 of mobile device 120 to determine the location of homeowner 101 and identify what stores and/or businesses homeowner 101 frequently visits.

At process 406, mobile investment circuit 140 selects one or more investment opportunities based on the preferences of homeowner 101 and the financial information of homeowner 101. In some embodiments, the investment opportunities are selected from the investment pool generated at process 402. The investment opportunities may be selected based on preference of homeowner 101. For example, if homeowner 101 indicates a preference for peer-to-peer loans, mobile investment circuit 140 may select peer-to-peer loans as the investment opportunity for homeowner 101. In various embodiments, the investment opportunities for homeowner 101 may be selected based on a preferred risk level indicated by homeowner 101 and a risk level associated with each of the investment opportunities. As an example, risk levels of bonds may be low while risk levels associated with peer-to-peer loans may be higher. The preferred risk level of homeowner 101 can be used to identify investment opportunities which are relevant for homeowner 101. If the risk level is above a predefined amount, the investment opportunities selected may include loans (e.g., peer-to-peer loans). If the risk level is below the predefined amount, the investment opportunities selected may include stock and/or bond investments. A similar determination can be performed with the remaining mortgage period of a home of homeowner 101, that is, investment opportunities can be selected based on the remaining mortgage period. For example, if the remaining mortgage term is within a predefined amount of time, the selected investment opportunities selected may only include peer-to-peer loans. If the remaining mortgage term is greater than a predefined amount of time, the selected investment opportunities may only include stock and bond investments.

Mobile investment circuit 140 can further select the investment opportunities based on financial information associated with the entity offering the investment opportunity. In some embodiments, the financial information is credit score. If the credit score of the entity associated with the investment opportunity is above the predefined amount, mobile investment circuit 140 may selected the investment opportunity for homeowner 101. For example, if peer-to-peer loans are being considered for homeowner 101, the credit score for each loan requestors for the identified peer-to-peer loans may be retrieved from a financial institution (e.g., financial institution 130) by mobile investment circuit 140. If the credit score of the of the loan requestor is below a predefined amount, the peer-to-peer loan associated with the loan requestor may not be selected for presentation to homeowner 101 for consideration. Mobile investment circuit 140 can receive the credit score from loan network 170, investor 181, and/or any other entity.

At process 408, mobile investment circuit 140 provides the selected investment opportunities to the mobile device 120 for approval by homeowner 101. An approved investment opportunity is an investment opportunity which homeowner 101 has consented to invest in. In some embodiments, homeowner 101 receives a notification including the selected investment opportunities via mobile investment client application 122. The notification may include a list of all the investment opportunities selected at process 406. Homeowner 101 may be able to select one or more investments from the list via touch screen display 205 of mobile device 120. In various embodiments, the list of investment opportunities may be ranked from highest return to lowest return. In other embodiments, the investment opportunities may be ranked based on risk (e.g., highest risk to lowest risk or lowest risk to highest risk). In various embodiments, homeowner 101 can select parameters for sorting the investment opportunities via mobile device 120.

At process 410, mobile investment circuit 140 receives an indication of one or more approved investment opportunities. The indication may be a message generated by mobile device 120. The message can indicate which investment opportunities homeowner 101 has approved and which investment opportunities homeowner 101 has declined. In various embodiments, the message can include investment opportunities which homeowner 101 wishes to be saved for consideration at a later time.

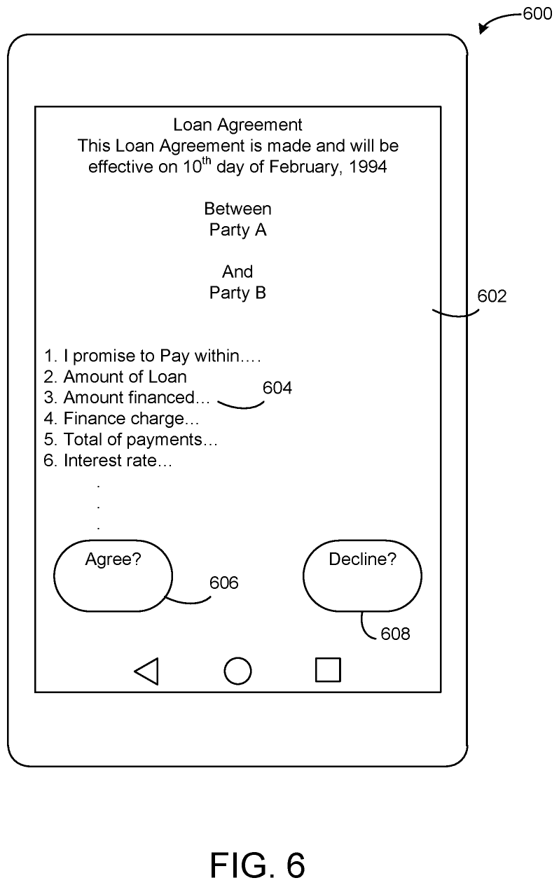

At process 412, mobile investment circuit 140 and/or mobile investment client application 122 generates an agreement for the one or more approved investment opportunities. In some embodiments, mobile investment circuit 140 generates the agreement and sends the agreement to mobile device 120. In other embodiments, mobile investment client application 122 generates the agreement at the direction of mobile investment circuit 144. In various embodiments, the agreement can be an agreement for a peer-to-peer loan, a stock, or a bond. In various embodiments, the agreement is generated with conditional language applicable for the type (e.g., stock, bond, loan, etc.) of the investment. Generating the loan agreement is discussed in greater detail with respect to FIG. 6, and elsewhere herein.

At process 414, mobile investment circuit 140 and/or mobile investment client application 122 confirm the identity of homeowner 101. In some embodiments, the identity of homeowner 101 is confirmed via a fingerprint. For example, mobile device 120 may prompt homeowner 101 to enter a fingerprint via biometric scanner 208. Mobile device 120 can compare this fingerprint to a known fingerprint. If the match level between fingerprints is higher than a predefined amount, a notification may be sent to mobile investment circuit 140 confirming the identity of homeowner 101. Matching the fingerprints is described in further detail in FIG. 2 and elsewhere herein.

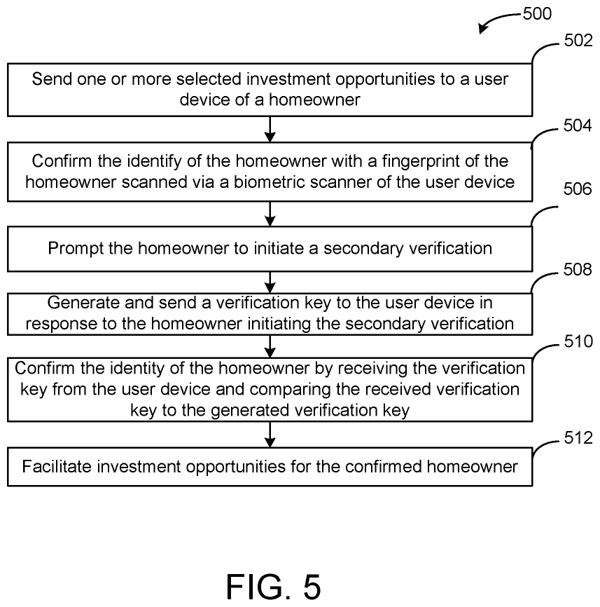

In various embodiments, financial institution computing system 131 can be configured to generate and send a verification key to mobile device 120. In some embodiments, the verification key can be used to confirm the identity of the user. Homeowner 101 may receive the verification key via an email, text, phone call, and/or any other method of delivery which homeowner 101 elects via mobile device 120. Homeowner 101 may enter the verification key into mobile device 120 for transmission to mobile investment client circuit 140. Mobile investment circuit 140 can confirm the identity of the user if the entered key matches the generated key. Confirming the identity of homeowner 101 is described in greater detail in FIG. 5 and elsewhere herein.

At process 416, mobile investment circuit 140 facilitates participation in the one or more approved investment opportunities. In response to receiving a confirmation that homeowner 101 has accepted the investment opportunity, mobile investment circuit 140 can communicate with investors to facilitate the investment. The investors may be loan network computer system 171, investor computer system 181, and/or any other investor. In various embodiments, financial institution computing system 131 communicates with other individuals who have financial accounts with financial institution 130 that may wish to invest the home equity of homeowner 101. Mobile investment circuit 140 can be configured to cause the investors to invest the equity of the home of homeowner 101 based on the investment opportunities approved by homeowner 101. Once the equity is invested, homeowner 101 may be able to view a new equity value in an online mortgage account. In some embodiments, the online mortgage account may indicate the current equity value of a property of homeowner 101, the amount of equity invested in investment opportunities, the types of investment opportunities invested in (e.g., bond, loan, stock, etc.) and the amount of equity invested in each investment opportunity.

At process 418, mobile investment circuit 140 provides rewards to homeowner 101 based on the homeowner preferences and the homeowner financial information. In some embodiments, mobile investment circuit 140 determines rewards for homeowner 101 based on the information received from the homeowner information database 138 and provide the rewards to homeowner 101. In some embodiments, the rewards are determined based on the number of mortgage payments made on time within a predefined window of time. For example, if homeowner 101 has made a predefined amount of mortgage payments on time in a certain time period (e.g., one year), mobile investment circuit 140 may provide a reward to homeowner 101. If the number of mortgage payments made on time within the time period is below a predefined amount, the homeowner 101 may not qualify for any rewards.

In some embodiments, the rewards are selected for homeowner 101 based on the homeowner preferences. The preferences may indicate favorite stores, online retailers, and/or any other preference associated with homeowner 101 that is received at process 404. Based on these preferences, one or more rewards may be selected from all available rewards. In this regard, homeowner 101 may only be presented with rewards that are relevant to homeowner 101 or are likely to be desired by homeowner 101. Examples of provided rewards are disclosed below.

As an example, the rewards are provided to the homeowner 101 by mailing a gift card to the homeowner 101. As another example, the rewards are automatically provided to homeowner 101. Financial institution 130 may be linked to a utility account of homeowner 101. In this regard, mobile investment circuit 140 may be configured to automatically make payments on the utility bills associated with the utility account of homeowner 101. In various embodiments, if groceries are purchased with a credit card held by homeowner 101 that is associated with financial institution 130, financial institution 130 may be configured to credit the credit card account with a refund for some and/or all of groceries purchased with the credit card held by homeowner 101. Regarding mortgages, if the mortgage of homeowner 101 is associated with financial institution 130, as still another example, mobile investment circuit 140 may forego and/or remit various amounts of the mortgage of homeowner 101. In some embodiments, the rewards are provided to the homeowner 101 via a mobile wallet (e.g., a prepaid debit card provisioned to the mobile wallet account/application) and may enable the homeowner to purchase items from stores and/or businesses which have contracts with the financial institution 130.

Referring now to FIG. 5, a process 500 for confirming the identity of a homeowner with the mobile devices of FIGS. 1 and 2 is shown, according to an example embodiment. Because process 500 may be performed using the financial institution computing system 131, the mobile device 120, the third party entity computer system 161, and other relevant components of the previous figures, reference to FIGS. 1, and 2 may be made to aid explanation of the process 500.

At process 502, selected investment opportunities may be sent by financial institution computing system 131 to mobile device 120. In some embodiments, the selected investment opportunities are the investment opportunities selected at process 406 as described with reference to FIG. 4. The selected investment opportunities may be sent to both mobile device 120 and third party entity computer system 161. Homeowner 101 may accept and/or reject the selected investment opportunities via mobile device 120. A notification of homeowner 101 accepting or rejecting the investment opportunity may be sent by mobile device 120 to financial institution computing system 131.

At process 504, the identity of homeowner 101 may be confirmed via a fingerprint scanned by biometric scanner 208. In some embodiments, each entity participating in the investment opportunity (e.g., third party entity 160) may be prompted to enter a fingerprint on a mobile device (e.g., mobile device 120). In some embodiments, each member is only prompted to enter a fingerprint if their mobile device has a biometric scanner (e.g., biometric scanner 208). A known fingerprint of homeowner 101 may be stored on mobile investment client application 122 and/or mobile investment circuit 140. In some embodiments, processor 209 of mobile device 120 compares a scanned fingerprint to the fingerprint stored by mobile investment client application 122. If the fingerprints match above a predefined level, the identity of homeowner 101 may be confirmed. In some embodiments, the fingerprint scanned by biometric scanner 308 is a digital signature for an agreement. This digital signature may be transmitted to the financial institution computing system 131 for permanent and/or temporary storage.

In some embodiments, the identity of homeowner 101 may be confirmed via a retinal scan. In this embodiment, biometric scanner 208 may be a retinal scanner that can confirm the identity of homeowner 101. In yet another embodiment, the identity of homeowner 101 can be confirmed via facial recognition. Mobile device 120 may include a camera that can be utilized to confirm the identity of homeowner 101 via digital signal processing and comparing a known facial image of homeowner 101 to an second facial image of homeowner 101 captured by the camera. In other embodiments, the identity of homeowner 101 can be confirmed via voice recognition. Mobile device 120 may include a microphone which can be used to record the voice of homeowner 101 and identify various voice biometrics. If the voice biometrics are consistent with known voice biometrics of homeowner 101, the identity of homeowner 101 can be confirmed by mobile device 120. The identity of homeowner 101 can be confirmed via user name and password, drawing certain objects on touch screen display 205, connecting various dots displayed on touch screen display 205 in a predefined sequence, answering various security questions such as, “What is your Mother's maidens name?”, and/or any other method that can be used to confirm the identity of homeowner 101.

At process 506, homeowner 101 is prompted via mobile device 120 to initiate a secondary verification. A secondary verification may include financial institution computing system 131 generating a verification key. The verification key may be a combination of numbers and/or letters (i.e., numeric and/or alphanumeric). The verification key may be any length which financial institution computing system 131 determines is appropriate. In some embodiments, the verification key is a word or phrase. In some embodiments, homeowner 101 may select, via mobile device 120, one of a plurality of phone numbers and/or email addresses which have been previously registered with the financial institution 130 to be used in delivering the verification key. In some embodiments, homeowner 101 may be prompted to select either a text message or a phone call as the delivery message when homeowner 101 selects a phone number for delivery of the verification key. In some embodiments, the phone number is at least one of a mobile phone number or a landline phone number.

At process 508, financial institution computing system 131 sends the verification key via a message (e.g., a text, an email, a phone call) to mobile device 120. In some embodiments, the phone call contains a generated phone message which includes the verification key. The message may be delivered via a phone call, a text message, and/or an email message.

At process 510, the mobile device 120 prompts the user to enter the verification key into a window or text box. In some embodiments, the user of mobile device 120 types the verification key into the mobile device 120. In various embodiments, the verification key is sent to financial institution computing system 131 (i.e., mobile investment circuit 140). Mobile investment circuit 140 may match the verification key received with a stored verification key (i.e., the verification key generated and sent to t mobile device 120). If the keys match, the identity of homeowner 101 is confirmed. Mobile investment client circuit 140 may send a notification to mobile device 120 that there is a key match. Once the keys match, homeowner 101 may be allowed to approve and/or reject the investment opportunity and/or investment opportunity agreement. If the investment opportunity agreement has already been accepted or rejected by homeowner 101, mobile device 120 may receive a confirmation that the investment opportunity agreement acceptance or rejection has been verified. The confirmation may be displayed on touch screen display 205.

At process 512, the financial institution computing system 131 facilitates the investment opportunities for the confirmed homeowner. In some embodiments, financial institution computing system 131 only facilitates the investment opportunities if the identity of homeowner 101 has been confirmed in process 504 and/or process 510. In some embodiments, process 512 includes some and/or all of the steps of process 418 as described with reference to FIG. 4. Once the investment has been facilitated, financial institution computing system can send a receipt or confirmation to the homeowner 101 and/or third party entity 160. The confirmation may be generated by financial institution computing system 131 and served via an email, text message, automated phone call, or any other method of serving the confirmation.

Referring now to FIG. 6, an example of an investment agreement displayed on mobile device 600 is shown, according to an exemplary embodiment. Mobile device 120 of FIGS. 1-2 can perform any and/or all of the functionality of mobile device 600. In some embodiments, the mobile device 600 is third party entity computer system 161 as described with reference to FIG. 1 or a computer system associated with any individual participating in an investment opportunity (e.g., a loan requestor), and/or any other relevant mobile device. In FIG. 6, an agreement 602 is shown to be displayed on a mobile device 600. Agreement 602 is shown to be an agreement for accepting or rejecting a loan, however, agreement 602 can be an agreement for any investment opportunity (e.g., stock investment, bond investment). Information 604 corresponding to terms of the investment opportunity is shown to be displayed on mobile device 600. Information 604 may be auto generated by mobile device 600. The mobile device 600 may be configured to automatically generate agreement 602 and information 604. The mobile device 600 can generate (e.g., automatically populate) the date, the legal name of each party participating in the loan agreement, the conditions of a loan, the date of maturity for a bond, the stock price of a stock, etc. In some embodiments, the information 604 is generated by financial institution computing system 131 and is automatically served to the mobile device 600.

Information 604 may include predefined text. The predefined text may include text selected by the financial institution 130. In some embodiments, financial institution 130 determines what the appropriate format for information 604. In some embodiments, the format for information 604 may change based on the nature of the investment opportunity. In some embodiments, conditional language applying to collateral may be appropriate for agreement 602 when agreement 602 is for a loan in which collateral is present. In some embodiments conditional language may change for a business loans and a personal loans. Any number of conditional language selections can be made by financial institution 130 or mobile device 600. In some embodiments, financial institution computer system 131 may be configured to generate agreement 602 and its appropriate format and serve the agreement 602 to the mobile device 600. In some embodiments, mobile device 600 generates agreement 602 based on information received from the financial institution computing system 131.

In some embodiments, mobile device 600 is connected to the loan network computer system 171 and/or investor computer system 181. In some embodiments, mobile device 600 receives information regarding a loan (e.g. peer-to-peer, collateral, personal or business loan, etc.) from loan network computer system 171 and generates the agreement 602 based on the information. In various embodiments, mobile device 600 receives stock or bond information from investor computer system 181 and generates agreement 602 based on the stock or bond information.

Agreement 602 may include an agree button 606 and a decline button 608 or any other such method for accepting and/or rejecting the loan. In some embodiments, accept button 606 must be pressed by the user of mobile device 600 to approve the investment. In some embodiments, the individuals are the homeowner 101, third party entity 160, an individual applying for a loan via loan network 170, an entity selling a stock, etc. In some embodiments, once all individuals participating in the investment press agree button 606, the mobile device 600 may ask each individual participating in the investment to digitally sign the loan document. In some embodiments, digitally signing agreement 602 is pressing agree button 606 via a touch screen. In some embodiment, the mobile device 600 may prompt the user of mobile device 600 to sign their name on the screen. In some embodiments, digitally signing agreement 602 is typing the individuals full legal name on the screen. In some embodiments, the individual entering into the loan and/or the loan officer (e.g., third party entity 160) must enter a fingerprint through a biometric scanner such as biometric scanner 208. In some embodiments, digitally signing agreement 602 is performing secondary verification (i.e., phone call with confirmation number).

In some embodiments, if one of the individuals participating in the investment presses the decline button 608, the mobile device may present the individual with a series of questions. The series of questions may ask the individual why the individual has not accepted the loan. For example, the questions may be questions such as, “Was the loan period to long?”, “Was the loan period to short?”, “Was there to much risk involved?”, or any other question. In some embodiments, mobile device 600 is configured to enter the responses to the mobile device into the homeowner information database 138. The response may be used when selecting loans in the future.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. An apparatus, comprising:
a biometric scanner configured to collect biometric data associated with a user;
a global positioning system configured to determine a position of the apparatus;
a network interface coupled to a first financial institution computing system associated with a first financial institution and a second financial institution computing system associated with a second financial institution, the first financial institution not associated with the second financial institution, the network interface operable to receive equity information regarding two or more accounts of the user, the equity information regarding two or more accounts including an equity value of a property of the user or a remaining mortgage period for the property;
a memory storing a known biometric of the user and one or more preferences of the user; and
a processor communicably coupled to the biometric scanner, the global positioning system, the network interface, and the memory, the processor, in response to the biometric data collected, configured to:
establish, via the network interface, a secure communication session with the first financial institution and the second financial institution computing system, wherein data communicated during the secure communication session is encrypted;
register the user with an equity investment program operated by one of the first financial institution computing system and the second financial institution computing system, the equity investment program configured to match users owning one or more properties with investment opportunities;
receive, from the global positioning system, location information regarding the apparatus;
determine, based on the location information, one or more locations that the user visits on a regular basis;
select an investment opportunity from a pool of investment opportunities, the pool of investment opportunities including a peer-to-peer loan and a bond, the investment opportunity selected based on the determined one or more locations that the user visits on a regular basis and at least one of the equity value of the property, the remaining mortgage period for the property, and the one or more preferences of the user, wherein the investment opportunity is retrieved via the network interface from the one of the first financial institution computing system and the second financial institution computing system, and wherein selecting the investment opportunity includes:
selecting the peer-to-peer loan as the investment opportunity in response to a determination that the equity value is above a predefined threshold or the remaining mortgage period for the property is below a predefined amount, wherein selecting the peer-to-peer loan includes matching the user with an individual requesting the peer-to-peer loan by identifying a credit indicator value associated with the individual requesting the peer-to-peer loan and the credit indicator value meeting an acceptable threshold value, the individual registered with the equity investment program and holding an account with the one of the first financial institution and the second financial institution; and
selecting the bond as the investment opportunity in response to a determination that the equity value is below the predefined threshold or the remaining mortgage period is above the predefined amount;
provide only the selected investment opportunity to the user;
receive, from the user, an indication of an approval of the selected investment opportunity;
responsive to receiving the indication, generate an investment opportunity agreement for the selected investment opportunity, the investment opportunity agreement requiring a digital signature;
generate and display a graphical user interface depicting information regarding the investment opportunity agreement, an agree button selectable to accept the investment opportunity agreement, and a decline button selectable to decline the investment opportunity agreement, wherein the agree button is locked until the user is verified, wherein the agree button and the decline button are disposed on the graphical user interface along with the information regarding the investment opportunity agreement which includes an execution date for the investment opportunity agreement, a name of the user on the investment opportunity agreement, and one or more parameters regarding the investment opportunity agreement;
prompt the user to provide a biometric input, the biometric input required to verify an identity of the user and digitally sign the investment opportunity agreement;
receive the biometric input regarding the user from the biometric scanner in response to the prompt;
initiate a secondary verification using verification information other than the biometric data collected, wherein the verification information includes a generated verification key by the one of the first financial institution computing system and the second financial institution computing system provided to the user via a communication means selected by the user via the graphical user interface, the generated verification key configured to facilitate verification of the identity of the user;
verify the identity of the user based on determining a verification key received via the selected communication means and entered by the user matches the generated verification key and based on determining that the received biometric input from the biometric scanner matches the known biometric of the user, wherein the determination that the received biometric input matches the known biometric comprises performing a pattern-matching process to determine that a degree of matching between the received biometric input and the known biometric exceeds a threshold;
in response to verifying the identity of the user, receive an input from the user selecting the agree button that becomes selectable based on verification of the identity of the user and digitally sign the investment opportunity agreement using the received biometric input to facilitate the user's participation in the selected investment opportunity according to the investment opportunity agreement, wherein digitally signing the investment opportunity agreement comprises transmitting the received biometric input to the one of the first financial institution computing system and the second financial institution computing system for storage;
determine that the user is eligible for a reward in response to a determination that a number of timely payments made within a predefined window of time is above a predefined amount; and
automatically provide, based on the determination that the user is eligible for the reward and the determined one or more locations that the user visits on a regular basis, the reward to the user.

2. (canceled)

3. The apparatus of claim 1, wherein the digital signature comprises a fingerprint image based on the biometric input.

4-5. (canceled)

6. The apparatus of claim 1, wherein the processor is configured to:
retrieve, via the network interface and from the one of the first financial institution and the second financial institution computing system, mortgage payment information of the user, the mortgage payment information comprising a number of timely mortgage payments made by the user within the predefined window of time.

7. The apparatus of claim 6, wherein the processor is configured to:
retrieve, from the memory or via the network interface, reward preferences associated with the user; and
automatically select the reward based on the reward preferences of the user.

8. The apparatus of claim 7, wherein automatically providing the selected reward to the user comprises instructing, via the network interface, the one of the first financial institution and the second financial institution computing system to automatically credit a credit card associated with the user for a purchase associated with the one or more locations that the user visits on a regular basis.

9. A method performed by a mobile device for engaging a user with an investment opportunity, the method comprising:
establishing, via a network interface of the mobile device, a secure communication session with a first financial institution computing system associated with a first financial institution and a second financial institution computing system associated with a second financial institution, the first financial institution not associated with the second financial institution, wherein data communicated during the secure communication session is encrypted;
registering the user with an equity investment program operated by one of the first financial institution computing system associated with the first financial institution and the second financial institution computing system associated with the second financial institution, the equity investment program configured to match users owning one or more properties with investment opportunities;
executing, upon a request by the user, an application of the mobile device, the application loading a stored profile of the user;
retrieving, from the one of the first financial institution computing system and the second financial institution computing system by the mobile device, equity information regarding two or more accounts of the user, the equity information comprising an equity value of a property of the user or a remaining mortgage period for the property;
retrieving, from the financial institution computing system by the mobile device, one or more preferences of the user;
receiving, from a global positioning system, location information regarding the mobile device;
determining, based on the received location information, one or more locations that the user visits on a regular basis;
automatically selecting, by a mobile investment circuit of the mobile device, an investment opportunity from a pool of investment opportunities, the pool of investment opportunities including a peer-to-peer loan and a bond, the investment opportunity selected based on at least one of the equity value, the remaining mortgage period, and the one or more preferences, wherein the investment opportunity is retrieved via the network interface from the one of the first financial institution computing system and the second financial institution computing system, and wherein automatically selecting the investment opportunity includes:
selecting the peer-to-peer loan as the investment opportunity in response to a determination that the equity value is above a predefined threshold or the remaining mortgage period for the property is below a predefined amount, wherein selecting the peer-to-peer loan includes matching the user with an individual requesting the peer-to-peer loan by identifying a credit indicator value associated with the individual requesting the peer-to-peer loan and the credit indicator value meeting an acceptable threshold value, the individual registered with the equity investment program and holding an account with the one of the first financial institution and the second financial institution; and
selecting the bond as the investment opportunity in response to a determination that the equity value is below the predefined threshold or the remaining mortgage period is above the predefined amount;
providing only the selected investment opportunity to the user;
receiving, from the user, an indication of an approval of the provided selected investment opportunity;
upon receiving the indication of the approval of the provided selected investment opportunity from the user, generating, by the mobile investment circuit, an investment opportunity agreement for the provided selected investment opportunity, the investment opportunity agreement requiring a digital signature;
generating and providing, by the mobile investment circuit, a graphical user interface via a display of the mobile device, the graphical user interface depicting information regarding the investment opportunity agreement, an agree button selectable to accept the investment opportunity agreement, and a decline button selectable to decline the investment opportunity agreement, wherein the agree button is locked until the user is verified, wherein the agree button and the decline button are disposed on the graphical user interface along with information regarding the investment opportunity agreement which includes an execution date for the investment opportunity agreement, a name of the user on the investment opportunity agreement, and one or more parameters regarding the investment opportunity agreement;
prompting, by the mobile investment circuit, the user to provide a biometric input, the biometric input required to verify an identity of the user and digitally sign the investment opportunity agreement;
receiving, from a biometric scanner, the biometric input regarding the user in response to the prompt;
upon receiving the biometric input, initiating a secondary verification using verification information other than the received biometric input;
upon receiving, from the one of the first financial institution computing system and the second financial institution computing system by the mobile device via a communication means selected by the user via the graphical user interface, a verification key generated in response to the secondary verification initiation, verifying, by the mobile investment circuit, the identity of the user based on determining a verification key received via the selected communication means and entered by the user matches the generated verification key and based on determining that the received biometric input from the biometric scanner matches a known biometric of the user stored in a memory of the mobile device, wherein the determination that the received biometric input matches the known biometric comprises performing a pattern-matching process to determine that a degree of matching between the received biometric input and the known biometric exceeds a threshold;
in response to verifying the identity of the user, receiving an input from the user selecting the agree button that becomes selectable based on verification of the identity of the user and digitally signing, by the mobile investment circuit, the investment opportunity agreement using the received biometric input to facilitate the participation of the user in the provided selected investment opportunity according to the investment opportunity agreement, wherein digitally signing the investment opportunity agreement comprises transmitting the received biometric input to the one of the first financial institution computing system and the second financial institution computing system for storage;
determining that the user is eligible for a reward in response to a determination that a number of timely payments made within a predefined window of time is above a predefined amount; and
automatically providing, based on the determination that the user is eligible for the reward and the determined one or more locations that the user visits on a regular basis, the reward to the user.

10. (canceled)

11. The method of claim 9, wherein the digital signature comprises a fingerprint image based on the biometric input.

12-13. (canceled)

14. The method of claim 9, further comprising:
receiving, by the mobile investment circuit, mortgage payment information of the user comprising a number of timely loan payments made by the user within a predefined window of time.

15. The method of claim 14, further comprising selecting, by the mobile investment circuit, the reward based on reward preferences of the user.

16. The method of claim 15, wherein automatically providing the selected reward to the user comprises instructing the one of the first financial institution computing system and the second financial institution computing system to automatically credit a credit card associated with the user for a purchase associated with the one or more locations that the user visits on a regular basis.

17. A computing system, comprising:
a biometric scanner configured to collect biometric data of a user;
a global positioning system configured to determine a position of a device associated with the user;
a network interface coupled to a first financial institution computing system associated with a first financial institution and a second financial institution computing system associated with a second financial institution, the network interface operable to receive information regarding two or more accounts of the user, the information including an equity value of a property of the user and a remaining mortgage period for the property;
a processor communicably coupled to the biometric scanner and the global positioning system, the processor configured to:
establish, via the network interface, a secure communication session with the first financial institution computing system and the second financial institution computing system, wherein data communicated during the secure communication session is encrypted;
register the user with an equity investment program operated by one of the first financial institution computing system and the second financial institution computing system, the equity investment program configured to match users owning one or more properties with investment opportunities;
retrieve, from the one of the first financial institution computing system and the second financial institution computing system, equity information regarding an equity value of a property of the user or a remaining mortgage period for the property;
retrieve, from the one of the first financial institution computing system and the second financial institution computing system, one or more preferences of the user;
receive, from the global positioning system, location information regarding the device;
determine, based on the received location information, one or more locations that the user visits on a regular basis;
select an investment opportunity from a pool of investment opportunities, the pool of investment opportunities including at least a peer-to-peer loan and a bond the investment opportunity based on at least one of the equity value of the property, the remaining mortgage period for the property, and the one or more preferences of the user, wherein the investment opportunity is retrieved via the network interface from the one of the first financial institution computing system and the second financial institution computing system, wherein selecting the investment opportunity includes:
selecting the peer-to-peer loan as the investment opportunity in response to a determination that the equity value is above a predefined threshold or the remaining mortgage period for the property is below a predefined amount, wherein selecting the peer-to-peer loan includes matching the user with an individual requesting the peer-to-peer loan by identifying a credit indicator value associated with the individual requesting the peer-to-peer loan and the credit indicator value meeting an acceptable threshold value, the individual registered with the equity investment program and holding a second account with the one of the first financial institution and the second financial institution; and
selecting the bond as the investment opportunity in response to a determination that the equity value is below the predefined threshold or the remaining mortgage period is above the predefined amount;
provide only the selected investment opportunity to the user;
upon receiving an approval of the selected investment opportunity from the user, generate an investment opportunity agreement for the selected investment opportunity, the generated investment opportunity agreement requiring a digital signature;
generate and display a graphical user interface depicting information regarding the investment opportunity agreement, an agree button selectable to accept the investment opportunity agreement, and a decline button selectable to decline the investment opportunity agreement, wherein the agree button is locked until the user is verified, wherein the agree button and the decline button are disposed on the graphical user interface along with the information regarding the investment opportunity agreement which includes an execution date for the investment opportunity agreement, a name of the user on the investment opportunity agreement, and one or more parameters regarding the investment opportunity agreement;
prompt the user to provide a biometric input in response to generating and displaying the graphical user interface and before the user provides an input selecting the agree button, the biometric input required to verify an identity of the user and digitally sign the generated investment opportunity agreement;
receive the biometric input regarding the user from the biometric scanner;
upon receiving the biometric input from the biometric scanner, initiate a secondary verification using verification information other than the biometric input, the verification information including a verification key generated by the financial institution computing system provided to the user via a communication means selected by the user via the graphical user interface, the generated verification key configured to facilitate verification of the identity of the user;
verify the identity of the user based on determining a verification key received via the selected communication means and entered by the user matches the generated verification key and based on determining that the biometric input from the biometric scanner matches a known biometric of the user, wherein the determination that the biometric input from the biometric scanner matches the known biometric comprises performing a pattern-matching process to determine that a degree of matching between the biometric input from the biometric scanner and the known biometric exceeds a threshold;
in response to verifying the identity of the user, receive an input from the user selecting the agree button that becomes available based on verification of the identity of the user and digitally sign the generated investment opportunity agreement using the received biometric input to facilitate the user's participation in the selected investment opportunity according to the generated investment opportunity agreement, wherein digitally signing the investment opportunity agreement comprises transmitting the biometric input from the biometric scanner to the one of the first financial institution computing system and the second financial institution computing system for storage;
determine that the user is eligible for a reward in response to a determination that a number of timely payments made within a predefined window of time is above a predefined amount; and
automatically provide, based on the determination that the user is eligible for the reward and the determined one or more locations that the user visits on a regular basis, the reward to the user.

18. (canceled)

19. The system of claim 17, wherein the digital signature comprises a fingerprint image based on the biometric input.

20. The system of claim 17, wherein the equity information comprising a number of timely loan payments made by the user within the predefined window of time.
